(19) United States
(12) Patent Application Publication
(10) Pub. No.: US 2019/0235131 A1
(43) Pub. Date: Aug. 1, 2019

(54) METHOD FOR PRODUCING A CUT OPTICAL FILM

(71) Applicant: ZEON CORPORATION, Tokyo (JP)

(72) Inventor: Takuya MIURA, Tokyo (JP)

(73) Assignee: ZEON CORPORATION, Tokyo (JP)

(21) Appl. No.: 16/378,577

(22) Filed: Apr. 9, 2019

Related U.S. Application Data
(63) Continuation of application No. 15/505,700, filed on Feb. 22, 2017, now abandoned.

(30) Foreign Application Priority Data
Aug. 28, 2014 (JP) 2014-174367

(51) Int. Cl. G02B 1/04; B29C 48/88; B29C 48/00; B29C 48/21; B29C 48/08; B32B 27/00; G02B 1/14; B29D 11/00; G02B 5/30; B29B 9/06; B23K 26/38; B23K 26/402; B29B 17/00

(52) U.S. Cl. CPC G02B 1/04; B23K 2101/36; B29C 48/0022; B29C 48/21; B29C 48/08; B29C 48/022; B32B 27/00; G02B 1/14; B29D 11/00788; G02B 5/3083; B29B 9/06; B23K 26/38; B23K 26/402; B29B 17/00; B29C 48/914

(57) ABSTRACT

A method for producing a cut optical film comprising a step of irradiating an optical film with CO₂ laser light to cut the optical film is provided. The optical film includes an olefin resin layer that contains a cyclic olefin polymer and an ester compound. The ratio of the ester compound in the olefin resin layer is 0.1% by weight to 10% by weight. An average light absorbance of the optical film in a wavelength range of 9 μm to 11 μm is 0.1% or more.

### CROSS-REFERENCE TO RELATED APPLICATIONS

This application is a continuation application of U.S. application Ser. No. 15/505,700 filed Feb. 22, 2017, which is a National Stage Application of PCT/JP2015/073741 filed Aug. 24, 2015, which claims priority based on Japanese Patent Application No. 2014-174367 filed Aug. 28, 2014. The disclosures of the prior applications are hereby incorporated by reference herein in their entirety.

### FIELD

The present invention relates to an optical film.

### BACKGROUND

A display device, such as a liquid crystal display device and an organic electroluminescent display device, may include an optical film formed of a resin. Usually, such an optical film is continuously produced in a production line as a long-length film having a desired width. Then, from the long-length film, a film piece of a desired shape suitable for a rectangular display surface of a display device is cut out. The cut-out film piece is provided to a liquid crystal display device.

Examples of a method for cutting a long-length optical film into a desired shape may include a mechanical cutting method using a knife and a laser cutting method using laser light. Of these, the laser cutting method is preferable as this method is less prone to generate cutting chips. Such a laser cutting method is described, for example, in Patent Literature 1.

### CITATION LIST

### Patent Literature

Patent Literature 1: Japanese Patent Application Laid-Open No. 2010-76181 A

### SUMMARY

### Technical Problem

In the laser cutting method, cutting of the optical film is usually performed in a state of being supported by a supporting surface of a suitable supporting body. If an output of laser light is excessive during this process, the supporting body may be damaged. Therefore, the output of laser light is required to be small.

However, in an attempt of cutting an optical film containing a cyclic olefin polymer with CO₂ laser light, it is difficult to cut the film with low-output CO₂ laser light. Thus, in an attempt of cutting the optical film containing a cyclic olefin polymer with CO₂ laser light, the output of CO₂ laser light needs to be increased, and consequently, the supporting body can be easily damaged.

The present invention has been created in view of the above-mentioned problems, and it is an object of the present invention to provide an optical film that contains a cyclic olefin polymer and that can be cut with low-output CO₂ laser light.

### Solution to Problem

The present inventor has intensively studied to solve the aforementioned problems. As a result, the inventor has found that an optical film including an olefin resin layer containing an ester compound at a specific ratio can be cut with a low-output CO₂ laser light when the optical film has an average light absorbance of a specific value or more in a wavelength range of 9 μm to 11 μm, thereby completing the present invention.

Specifically, the present invention is as follows.

(1) An optical film comprising an olefin resin layer that contains a cyclic olefin polymer and an ester compound, the ratio of the ester compound in the olefin resin layer being 0.1% by weight to 10% by weight, wherein

an average light absorbance of the optical film in a wavelength range of 9 μm to 11 μm is 0.1% or more.

(2) The optical film according to (1), wherein the cyclic olefin polymer contains no polar group in a molecule thereof.

(3) The optical film according to (1) or (2), wherein the optical film has a saturated water absorption rate of 0.05% or less.

(4) The optical film according to any one of (1) to (3), wherein the ester compound includes an aromatic ring in a molecule thereof.

(5) The optical film according to any one of (1) to (4), comprising a coating layer formed on one surface or both surfaces of the olefin resin layer.

(6) The optical film according to (5), wherein the coating layer is formed of a thermoplastic resin containing the cyclic olefin polymer.

(7) The optical film according to (5) or (6), wherein the coating layer contains no ester compound.

(8) The optical film according to any one of (5) to (7), wherein the cyclic olefin polymer in the coating layer contains no polar group in a molecule thereof.

### Advantageous Effects of Invention

According to the present invention, there can be provided an optical film containing a cyclic olefin polymer, which can be cut with low-output CO₂ laser light.

### DESCRIPTION OF EMBODIMENTS

Although the present invention will be described below in detail by way of embodiments and examples, the present invention is not limited to the embodiments, the examples, and the like described below and may be freely modified and practiced without departing from the scope of the claims of the present invention and equivalents thereto.

In the following description, an in-plane retardation of a film is a value represented by (nx−ny)×d, unless otherwise specified. Further, a thickness-direction retardation of a film is a value represented by {(nx+ny)/2−nz}×d, unless otherwise specified. In the formulas, nx represents a refractive index in a direction in which the maximum refractive index is given among directions perpendicular to a thickness direction of the film (in-plane direction), ny represents a refractive index in one of the above-mentioned in-plane direction, perpendicular to the direction giving nx, nz represents a refractive index in a thickness direction of the film, and d represents the thickness of the film. The above-mentioned retardation may be measured with a commercially available phase difference measurement apparatus (for example, “KOBRA-21ADH” manufactured by Oji Scientific Instruments and “WPA-micro” manufactured by Photonic Lattice, Inc.) or a Senarmont method. The measurement wavelength of retardation is 550 nm unless otherwise specified.

[1. Summary of Optical Film]

The optical film of the present invention includes an olefin resin layer containing a cyclic olefin polymer and an ester compound. Further, the optical film of the present invention may optionally include a coating layer.

[2. Olefin Resin Layer]

The olefin resin layer is a layer of a cyclic olefin resin containing a cyclic olefin polymer and an ester compound.

[2.1. Cyclic Olefin Polymer]

The cyclic olefin polymer refers to a polymer of a structural unit having an alicyclic structure. Usually, a resin containing such a cyclic olefin polymer is excellent in characteristics such as transparency, size stability, phase difference expression, and stretchability at a low temperature.

The cyclic olefin polymer may be a polymer having an alicyclic structure in a main chain, a polymer having an alicyclic structure in a side chain, a polymer having alicyclic structures in a main chain and a side chain, and a mixture of two or more of these polymers at any ratio. Of these, the polymer having an alicyclic structure in a main chain is preferable from the viewpoint of mechanical strength and heat resistance.

Examples of the alicyclic structure may include a saturated alicyclic hydrocarbon (cycloalkane) structure and an unsaturated alicyclic hydrocarbon (cycloalkene and cycloalkyne) structure. Of these, the cycloalkane structure and the cycloalkene structure are preferable from the viewpoint of mechanical strength and heat resistance. Of these, the cycloalkane structure is particularly preferable.

The number of carbon atoms constituting the alicyclic structure is preferably 4 or more, and more preferably 5 or more, and is preferably 30 or less, more preferably 20 or less, and particularly preferably 15 or less, per alicyclic structure. When the number of carbon atoms constituting the alicyclic structure is within this range, mechanical strength, heat resistance and moldability of the cyclic olefin resin are highly balanced.

In the cyclic olefin polymer, the ratio of the structural unit having the alicyclic structure may be selected in accordance with a purpose of use of the optical film of the present invention. The ratio of the structural unit having the alicyclic structure in the cyclic olefin polymer is preferably 55% by weight or more, further preferably 70% by weight or more, and particularly preferably 90% by weight or more. When the ratio of the structural unit having the alicyclic structure in the cyclic olefin polymer is within this range, transparency and heat resistance of the cyclic olefin resin become favorable.

Of the cyclic olefin polymers, a cycloolefin polymer is preferable. The cycloolefin polymer is a polymer having a structure that is obtained by polymerizing a cycloolefin monomer. Further, the cycloolefin monomer is a compound having a ring structure formed of carbon atoms and also having a polymerizable carbon-carbon double bond in the ring structure. Examples of the polymerizable carbon-carbon double bond may include a carbon-carbon double bond that can be polymerized in such a manner as a ring opening polymerization. Further, examples of the ring structure of the cycloolefin monomer may include monocyclic, polycyclic, fused polycyclic, cross-linked cyclic structures, and polycyclic structures that are combinations of the aforementioned structures. Of these, the polycyclic cycloolefin monomer is preferable from the viewpoint of highly balancing characteristics such as dielectric property and heat resistance of the obtained polymer.

Preferable examples of the cycloolefin polymers described above may include a norbornene-based polymer, a monocyclic olefin-based polymer, a cyclic conjugated diene-based polymer, and hydrogenated products thereof. Of these, the norbornene-based polymer is particularly preferable because of its favorable moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Further, examples of the ring-opening polymer of a monomer having a norbornene structure may include a ring-opening homopolymer of one type of a monomer having a norbornene structure, a ring-opening copolymer of two or more types of monomers having norbornene structures, and a ring-opening copolymer of a monomer having a norbornene structure and another monomer copolymerizable therewith. Further, examples of the addition polymer of a monomer having a norbornene structure may include an addition homopolymer of one type of a monomer having a norbornene structure, an addition copolymer of two or more types of monomers having norbornene structures, and an addition copolymer of a monomer having a norbornene structure and another monomer copolymerizable therewith. Of these, a hydrogenated product of the ring-opening polymer of a monomer having a norbornene structure is particularly preferable from the viewpoint of moldability, heat resistance, low hygroscopicity, size stability, lightweight property, and the like.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]deca-3-ene (common name: methanotetrahydrofluorene), tetracyclo[4.4.0.1^{2,5}.1^{7,10}]dodeca-3-ene (common name: tetracyclododecene), and derivatives of these compounds (for example, those having a substituent on the ring). Examples of the substituent herein may include an alkyl group, an alkylene group, and a polar group. Further, a plurality of such substituents may be bonded to the ring and these substituents may be the same or different from each other. As the monomer having a norbornene structure, one type thereof may be used alone, and two or more types thereof may also be used in combination at any ratio.

Examples of the polar group may include a hetero atom and an atomic group having a hetero atom. Examples of the hetero atom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, an amide group, an imide group, a nitrile group, and a sulfonic acid group.

Examples of the monomer copolymerizable with the monomer having a norbornene structure through ring-opening copolymerization may include monocyclic olefins such as cyclohexene, cycloheptene, and cyclooctene, and derivatives thereof; and cyclic conjugated dienes such as cyclohexadiene and cycloheptadiene, and derivatives thereof. As the monomer copolymerizable with the monomer having a norbornene structure through ring-opening copolymerization, one type thereof may be used alone, and two or more types thereof may also be used in combination at any ratio.

The ring-opening polymer of a monomer having a norbornene structure may be produced, for example, by polymerizing or copolymerizing such monomers in the presence of a ring-opening polymerization catalyst.

Examples of the monomer addition-copolymerizable with the monomer having a norbornene structure may include α-olefins having 2 to 20 carbon atoms such as ethylene, propylene, and 1-butene, and derivatives thereof; cycloolefins such as cyclobutene, cyclopentene, and cyclohexene, and derivatives thereof; and non-conjugated dienes such as 1,4-hexadiene, 4-methyl-1,4-hexadiene, and 5-methyl-1,4-hexadiene. Of these, the α-olefins are preferable, and ethylene is more preferable. Further, as the monomer addition-copolymerizable with the monomer having a norbornene structure, one type thereof may be used alone, and two or more types thereof may also be used in combination at any ratio.

The addition polymer of a monomer having a norbornene structure may be produced, for example, by polymerizing or copolymerizing such monomers in the presence of an addition polymerization catalyst.

A hydrogenated product of the ring-opening polymer and a hydrogenated product of the addition polymer described above may be produced, for example, by hydrogenating a carbon-carbon unsaturated bond preferably by 90% or more in a solution of the ring-opening polymer and the addition polymer in the presence of a hydrogenation catalyst containing transition metal such as nickel and palladium.

As the norbornene-based polymer, it is preferable that the polymer has an X: bicyclo [3.3.0] octane-2,4-diyl-ethylene structure and a Y: tricyclo [4.3.0.1^{2,5}] decane-7,9-diyl-ethylene structure as the structural units, and that the amount of these structural units is 90% by weight or more with respect to the entire structural units of the norbornene-based polymer, and the weight ratio of X and Y is 100:0 to 40:60. By using such a polymer, an olefin resin layer containing the norbornene-based polymer can exhibit excellent stability in optical characteristics without having a size change over a long period of time.

Examples of the monocyclic olefin-based polymer may include an addition polymer of a monocyclic olefin-based monomer such as cyclohexene, cycloheptene, and cyclooctene.

Examples of the cyclic conjugated diene-based polymer may include: a polymer obtained by cyclization reaction of an addition polymer of a conjugated diene-based monomer such as 1,3-butadiene, isoprene, and chloroprene; a 1,2- or 1,4-addition polymer of a cyclic conjugated diene-based monomer such as cyclopentadiene and cyclohexadiene; and hydrogenated products thereof.

Further, the above-mentioned cyclic olefin polymer preferably contains no polar group in its molecule. In the present application, “the cyclic olefin polymer containing no polar group in its molecule” means that the ratio of the monomer unit containing a polar group in the cyclic olefin polymer is 0.2 mol % or less. When the cyclic olefin polymer contains no polar group in its molecule, the lower limit of the ratio of the monomer unit containing a polar group in the cyclic olefin polymer may be set to 0.0 mol %. In general, the cyclic olefin polymer containing no polar group in its molecule tends to show low absorbance, particularly low absorbance of CO₂ laser light. However, even though the optical film of the present invention is formed of the cyclic olefin polymer containing no polar group in its molecule, the optical film can be easily cut with low-output CO₂ laser light. Further, a saturated water absorption rate of the optical film of the present invention can be reduced by using the cyclic olefin polymer containing no polar group in its molecule.

The weight average molecular weight (Mw) of the cyclic olefin polymer may be suitably selected in accordance with the purpose of use of the optical film, but is preferably 10,000 or more, more preferably 15,000 or more, and particularly preferably 20,000 or more, and is preferably 100,000 or less, more preferably 80,000 or less, and particularly preferably 50,000 or less. When the weight average molecular weight is in such a range, mechanical strength and moldability of the optical film are highly balanced. Herein, the above-mentioned weight average molecular weight is measured in terms of polyisoprene or polystyrene by a gel permeation chromatography using cyclohexane as a solvent (when the sample does not dissolve in cyclohexane, toluene may be used).

The molecular weight distribution (weight average molecular weight (Mw)/number average molecular weight (Mn)) of the cyclic olefin polymer is preferably 1.2 or more, more preferably 1.5 or more, and particularly preferably 1.8 or more, and is preferably 3.5 or less, more preferably 3.0 or less, and particularly preferably 2.7 or less. By limiting the molecular weight distribution to be equal to or higher than the above-mentioned lower limit value, productivity of the polymer can be improved and manufacturing cost can be reduced. Further, by limiting it to be equal to or lower than the upper limit value, the amount of low molecular components is reduced, whereby it is possible to suppress relaxation of the film during high-temperature exposure, and stability of the optical film can thus be improved.

The ratio of the cyclic olefin polymer in the olefin resin layer is preferably 90% by weight or more, more preferably 92% by weight or more, and particularly preferably 95% by weight or more, and is preferably 99.9% by weight or less, more preferably 99% by weight or less, and particularly preferably 98% by weight or less. By limiting the ratio of the cyclic olefin polymer to be equal to or higher than the lower limit value within the above-mentioned range, the saturated water absorption rate of the optical film can be kept at a low level. Further, by limiting it to be equal to or lower than the upper limit value, light absorbance in a wavelength range of 9 μm to 11 μm is increased and thus the optical film can be easily cut with CO₂ laser light.

[2.2. Ester Compound]

The ester compound contained in the olefin resin layer at a specific ratio can impart a capability of efficiently absorbing CO₂ laser light to the olefin resin layer. As a result, the optical film of the present invention including the olefin resin layer that contains such an ester compound can be easily cut with the above-mentioned laser light even if the output of the laser light is low.

Examples of the ester compound may include a phosphoric acid ester compound, a carboxylic acid ester compound, a phthalic acid ester compound, and an adipic acid ester compound. Further, as the ester compound, one type thereof may be used alone, and two or more types thereof may also be used in combination at any ratio. Of these, the carboxylic acid ester compound is preferable from the viewpoint of enabling the olefin resin layer to further efficiently absorb CO₂ laser light.

Examples of the phosphoric acid ester compound may include triphenyl phosphate, tricresyl phosphate, and phenyl diphenyl phosphate.

Examples of the carboxylic acid ester compound may include an aromatic carboxylic acid ester and an aliphatic carboxylic acid ester.

The aromatic carboxylic acid ester is an ester of an aromatic carboxylic acid and an alcohol.

Examples of the aromatic carboxylic acid to be used may include benzoic acid, phthalic acid, isophthalic acid, terephthalic acid, trimellitic acid, and pyromellitic acid. As the aromatic carboxylic acid, one type thereof may be used alone, and two or more types thereof may also be used in combination at any ratio.

As the alcohol, for example, a straight chain or branched alkyl alcohol may be used. Further, as the alcohol, a monohydric alcohol having one hydroxyl group per molecule may be used, and a polyhydric alcohol having two or more hydroxyl groups per molecule may also be used. Specific examples of the monohydric alcohol may include n-propanol, isopropanol, n-butanol, isobutanol, tert-butanol, n-pentanol, isopentanol, tert-pentanol, n-hexanol, isohexanol, n-heptanol, isoheptanol, n-ocatanol, isoocatanol, 2-ethylhexanol, n-nonanol, isononanol, n-decanol, isodecanol, lauryl alcohol, myristyl alcohol, palmityl alcohol, and stearyl alcohol. Further, specific examples of the polyhydric alcohol may include ethylene glycol, diethylene glycol, triethylene glycol, 1,2-propylene glycol, 1,3-propylene glycol, 1,3-butanediol, 1,4-butanediol, 1,5-hexanediol, 1,6-hexanediol, neopentyl glycol, and pentaerythritol. As the alcohol, one type thereof may be used alone, and two or more types thereof may also be used in combination at any ratio.

The aliphatic carboxylic acid ester is an ester of an aliphatic carboxylic acid and an alcohol.

Examples of the aliphatic carboxylic acid may include oxalic acid, malonic acid, succinic acid, glutaric acid, adipic acid, pimelic acid, suberic acid, azelaic acid, and sebacic acid. As the aliphatic carboxylic acid, one type thereof may be used alone, and two or more types thereof may also be used in combination at any ratio.

Examples of the alcohol may include the same alcohols as those exemplified as the alcohols for the aromatic carboxylic acid ester. Further, as the alcohol, one type thereof may be used alone, and two or more types thereof may also be used in combination at any ratio.

Further, the number of ester bond per molecule of the ester compound may be one, or two or more. Thus, as the ester compound, for example, a polyester compound may be used. The polyester compound may be produced by a reaction of a diprotic or higher acid and a polyhydric alcohol, in which a monoprotic acid or a monohydric alcohol may be used as a stopper as necessary.

Of the ester compounds mentioned above, an ester compound having an aromatic ring in a molecule is preferable, and an ester compound having an ester bond bonded to the aromatic ring is particularly preferable. Such a structure enables the olefin resin layer to absorb CO₂ laser light more efficiently. Thus, among the ester compounds mentioned above, the aromatic carboxylic acid ester, such as benzoic acid ester, phthalic acid ester, isophthalic acid ester, terephthalic acid ester, trimellitic acid ester, and pyromellitic acid ester, is preferable. In particular, the benzoic acid ester is preferable from the viewpoint of allowing the olefin resin layer to exhibit a particularly favorable absorption. Of the benzoic acid esters, diethylene glycol dibenzoate and pentaerythritol tetrabenzoate are particularly preferable.

Further, as the ester compound, those that is capable of functioning as a plasticizer in the cyclic olefin resin are preferable. Using the ester compound capable of functioning as a plasticizer enables the olefin resin layer to particularly efficiently absorb CO₂ laser light. In general, a plasticizer can easily enter a gap between polymer molecules in a resin and thus be favorably dispersed in the resin without forming a sea-island structure. This can prevent uneven absorption of laser light. It is assumed that this mechanism facilitate cutting of the entire film. However, the present invention is not limited by this assumption.

The molecular weight of the ester compound is preferably 300 or higher, more preferably 400 or higher, and particularly preferably 500 or higher, and is preferably 2200 or lower, more preferably 1800 or lower, and particularly preferably 1400 or lower. By limiting the molecular weight of the ester compound to be equal to or higher than the lower limit value within the above-mentioned range, bleedout can be suppressed. Further, by limiting it to be equal to or lower than the upper limit value, the ester compound can be allowed to function easily as a plasticizer, and further, it is possible to give the ester compound molecules an ability to initiate a quick response to heat application. Consequently cutting of the optical film can be facilitated.

Further, the melting point of the ester compound is preferably 20° C. or higher, more preferably 60° C. or higher, and particularly preferably 100° C. or higher, and is preferably 180° C. or lower, more preferably 150° C. or lower, and particularly preferably 120° C. or lower. By limiting the melting point of the ester compound to be equal to or higher than the lower limit value within the above-mentioned range, bleedout can be suppressed. Further, by limiting it to be equal to or lower than the upper limit value, the ester compound can be allowed to function easily as a plasticizer, and further, it is possible to give the ester compound molecules an ability to initiate a quick response to heat application. Consequently, cutting of the optical film can be facilitated.

The ratio of the ester compound in the olefin resin layer is usually 0.1% by weight or more, preferably 1% by weight or more, and more preferably 2% by weight or more, and is usually 10% by weight or less, preferably 9% by weight or less, and more preferably 8% by weight or less. By limiting the ratio of the ester compound to be equal to or higher than the lower limit value within the above-mentioned range, it is possible to impart a capability of efficiently absorbing CO₂ laser light to the olefin resin layer. Further, by limiting it to be equal to or lower than the upper limit value, the haze of the olefin resin layer can be reduced, whereby transparency of the optical film can be improved. Further, it is thereby possible to suppress a noticeable deformation on the cross sectional surface of the optical film, which may be caused by thermal melting upon cutting of the optical film with laser light.

[2.3. Optional Component]

The olefin resin layer may further include an optional component in addition to the cyclic olefin polymer and the ester compound. Examples of the optional component may include additives, such as: a coloring agent such as a pigment and dye; a fluorescent brightening agent; a dispersant; a thermostabilizer; a light stabilizer; an ultraviolet absorbing agent; an antistatic agent; an antioxidant; a microparticle; and a surfactant. One type of these components may be used alone, and two or more types thereof may also be used in combination at any ratio.

[2.4. Physical Property of Olefin Resin Layer]

The glass transition temperature of the cyclic olefin resin forming the olefin resin layer is preferably 100° C. or higher, more preferably 110° C. or higher, and particularly preferably 120° C. or higher, and is preferably 190° C. or lower, more preferably 180° C. or lower, and particularly preferably 170° C. or lower. When the glass transition temperature is within the above-mentioned range, an optical film having high durability can be easily produced. For example, when the optical film is a phase difference film, by limiting the glass transition temperature to be equal to or higher than the lower limit value within the above-mentioned range, it is possible to enhance durability of the phase difference film under a high temperature environment. Further, by limiting it to be equal to or lower than the upper limit value, a stretching treatment can be easily performed.

The absolute value of photoelastic coefficient C of the cyclic olefin resin is preferably 10×10⁻¹² Pa⁻¹ or less, more preferably 7×10⁻¹² Pa⁻¹ or less, and particularly preferably 4×10⁻¹² Pa⁻¹ or less. When the absolute value of photoelastic coefficient C is within the above-mentioned range, a high-performance optical film can be easily produced. For example, when the optical film is a phase difference film, fluctuation of in-plane retardation in the phase difference film can be reduced. The photoelastic coefficient C is a value expressed by C=Δn/σ, where Δn is a birefringence and σ is a stress.

[2.5. Thickness of Olefin Resin Layer]

The thickness of the olefin resin layer is preferably 1 μm or more, more preferably 5 μm or more, and particularly preferably 10 μm or more, and is preferably 100 μm or less, more preferably 50 μm or less, and particularly preferably 30 μm or less. By limiting the thickness of the olefin resin layer to be equal to or higher the lower limit value within the above-mentioned range, it is possible to impart a capability of efficiently absorbing CO₂ laser light to the olefin resin layer. Further, by limiting it to be equal to or lower than the upper limit value, the haze of the olefin resin layer can be reduced, whereby transparency of the optical film can be improved.

[3. Coating Layer]

The coating layer is formed on one surface or both surfaces of the olefin resin layer. The coating layer is preferably formed on both surfaces of the olefin resin layer. In this case, one of the coating layers may be the same as or different from the other coating layer. Since the coating layer can protect the olefin resin layer, the olefin resin layer can be prevented from being damaged. Further, the coating layer can prevent bleedout of components contained in the olefin resin layer.

The coating layer is usually formed of a resin. As such a resin, a thermoplastic resin containing a polymer and an optional component as necessary may be used.

Examples of the polymer contained in the coating layer may include polycarbonate, polymethyl methacrylate, polyethylene terephthalate, and a cyclic olefin polymer. One type of these polymers may be used alone, and two or more types thereof may also be used in combination at any ratio.

Of these, the cyclic olefin polymer is preferable as the polymer contained in the coating layer. The cyclic olefin polymer for use may be selected from a group of the cyclic olefin polymers described as cyclic olefin polymers that may be included in the olefin resin layer. In this manner, shrinkage of the olefin resin layer and the coating layer at the time of a temperature change can be made approximately to the same degree. Consequently, wrinkles in the optical film can be prevented. Further by using the cyclic olefin polymer, transparency and size stability of the optical film can be improved.

The cyclic olefin polymer in the coating layer preferably contains no polar group in its molecule. When a polymer containing no polar group is employed as the cyclic olefin polymer in the coating layer, the coating layer can be easily cut together with the olefin resin layer by using low-output CO₂ laser light, and the saturated water absorption rate of the optical film of the present invention can be reduced.

The ratio of the polymer in the coating layer is preferably 90% by weight or more, more preferably 92% by weight or more, and particularly preferably 95% by weight or more, and is preferably 99.9% by weight or less, and more preferably 99% by weight or less. By limiting the ratio of the polymer to be equal to or higher than the lower limit value within the above-mentioned range, adhesion of the olefin resin layer and the coating layer can be improved. Further, by limiting it to be equal to or lower than the upper limit value, it is possible to suppress a difference in the degree of shrinkage between the olefin resin layer and the coating layer.

As an example of the optional component that may be included in the coating layer, the same components as the optional components that may be included in the olefin resin layer may be mentioned. Further, the coating layer may include the ester compound described above as an optional component. The optical film can be cut with laser light even when the coating layer does not include the ester compound. However, when the coating layer contains the ester compound, the optical film can be cut with the laser light having a lower output. When the coating layer contains the ester compound, the ratio of the ester compound in the coating layer may be set within the same range as those for the above-mentioned ratio of the ester compound in the olefin resin layer. Further, one type of the optional components may be used alone, and two or more types thereof may also be used in combination at any ratio.

However, it is preferable that the coating layer formed on at least one of the surfaces of the olefin resin layer contains no ester compound. Thus, when the coating layer is formed on only one surface of the olefin resin layer, the coating layer preferably contains no ester compound. When the coating layers are formed on both the surfaces of the olefin resin layer, it is preferable that either one or both of the coating layers contain no ester compound. This can prevent bleedout of the ester compound. Consequently, a roll used during production and conveyance of the optical film can be prevented from being stained with the ester compound. Further, since the coating layer does not contain the ester compound, the saturated water absorption rate of the optical film can be reduced.

The glass transition temperature and the photoelastic coefficient C of the resin forming the coating layer preferably fall within the same ranges as those of the glass transition temperature and the photoelastic coefficient C for the cyclic olefin resin forming the olefin resin layer.

The thickness of each coating layer is preferably 0.1 μm or more, more preferably 1 μm or more, and particularly preferably 10 μm or more, and is preferably 100 μm or less, more preferably 50 μm or less, and particularly preferably 30 μm or less. By limiting the thickness of the coating layer to be equal to or higher than the lower limit value within the above-mentioned range, shrinkage can be suppressed. Further, by limiting it to be equal to or lower than the upper limit value, cutting of the optical film can be facilitated.

Further, the ratio of thickness of the coating layer with respect to thickness of the olefin resin layer (coating layer/olefin resin layer) is preferably 1/300 or more, more preferably 1/280 or more, and particularly preferably 1/250 or more, and is preferably 2/1 or less, more preferably 1/1 or less, and particularly preferably 1/2 or less. By limiting the ratio of thickness to be equal to or higher than the lower limit value within the above-mentioned range, it is possible to impart a capability of efficiently absorbing CO₂ laser light to the optical film. Further, by limiting it to be equal to or lower than the upper limit value, a haze in an optical film having a multilayer structure can be reduced, thereby enabling to improve transparency of the optical film.

[4. Physical Property and Size of Optical Film]

The optical film of the present invention has an average light absorbance of usually 0.1% or more, preferably 0.3% or more, and more preferably 0.5% or more in a wavelength range of 9 μm to 11 μm. By having such a high average light absorbance, the optical film can efficiently absorb light in a wavelength range of 9 μm to 11 μm in which a wavelength of CO₂ laser light is included. Consequently, the optical film can be favorably cut even if the output of CO₂ laser light is low. Although there is no upper limit in the average light absorbance described above, usually it is preferably 3% or less. It is assumed that the absorption of the CO₂ laser light is caused by the ester compound contained in the olefin resin layer. However, the present invention is not limited by this assumption.

The average light absorbance of the optical film in a wavelength range of 9 μm to 11 μm may be measured by the following method.

The light absorbance of the optical film is measured at wavelength intervals of 0.01 μm in the wavelength range of 9 μm to 11 μm. Then, an average value of these measured values is calculated. This average value may represent the average light absorbance of the optical film in the wavelength range of 9 μm to 11 μm. The light absorbance may be measured, for example, by using a Fourier transform infrared spectroscopic analyzer.

The average light absorbance of the optical film in the wavelength range of 9 μm to 11 μm can be confined within the above-mentioned range, for example, by adjusting the type and amount of the ester compound in the olefin resin layer.

CO₂ laser produces light with wavelengths of 9.4 μm and 10.6 μm. Thus, in order to efficiently cut the optical film of the present invention with the CO₂ laser light, the optical film preferably has its light absorbance as high as the above-mentioned range of the average light absorbance at at least one of the wavelengths of 9.4 μm and 10.6 μm. Further, preferably the optical film has the light absorbance as high as the above-mentioned range of the average light absorbance at both wavelengths of 9.4 μm and 10.6 μm, from the viewpoint of further increasing flexibility of cutting process.

The saturated water absorption rate of the optical film of the present invention is preferably 0.05% or less, more preferably 0.03% or less, and ideally zero %. By reducing the saturated water absorption rate of the optical film in this manner, it is possible to suppress deformation of the film on the cut surface and scattering of the resin at the time of cutting the optical film. Further, it is possible to suppress changes with the lapse of time in optical characteristics of the optical film.

The saturated water absorption rate of the optical film may be measured in accordance with JIS K7209 by the following procedures.

The optical film is dried at 50° C. for 24 hours and allowed to cool in a desiccator. Then, the weight (M1) of the dried optical film is measured.

The dried optical film is immersed in water for 24 hours in a chamber at a temperature of 23° C. and a relative humidity of 50% for completing saturation of the optical film with the water. Then, the optical film is taken out of the water to measure the weight (M2) of the optical film that has been immersed in the water for 24 hours.

The saturated water absorption rate of the optical film may be calculated from these measured values of the weight by the following formula.

Saturated water absorption rate (%)=[(M2−M1)/M1]×100(%)

The saturated water absorption rate of the optical film can be confined within the above-mentioned range by, for example, controlling the amount of the ester compound in the optical film, and adjusting the type of the polymer contained in the olefin resin layer and the coating layer.

The total light transmittance of the optical film is preferably 85% or more, and more preferably 90% or more, from the viewpoint of allowing the optical film to stably exert its function as an optical member. The light transmittance may be measured using a spectrophotometer (ultraviolet-visible-near-infrared spectrophotometer “V-570” manufactured by JASCO Corp.,) in accordance with JIS K0115.

The haze of the optical film is preferably 1% or less, more preferably 0.8% or less, and particularly preferably 0.5% or less. When the haze value is small, the clarity of an image displayed by a display device in which the optical film is incorporated can be increased. Herein, the haze is an average value calculated from measurement at five points using a “turbidity meter NDH-300A” manufactured by NIPPON DENSHOKU INDUSTRIES CO., LTD. in accordance with JIS K7361-1997.

The in-plane retardation Re and the thickness-direction retardation Rth of the optical film may be freely set in accordance with the use of the optical film. For example, when the optical film is used as a phase difference film, the specific range of the in-plane retardation Re is preferably 50 nm or more, and preferably 200 nm or less. Further, the specific range of the thickness-direction retardation Rth is preferably 50 nm or more, and preferably 300 nm or less.

The amount of residual volatile component of the optical film is preferably 0.1% by weight or less, more preferably 0.05% by weight or less, and further preferably 0.02% by weight or less. When the amount of residual volatile component falls within the above-mentioned range, it is possible to stably prevent changes with the lapse of time in optical characteristics of the optical film. Further, size stability of the optical film can be improved. Moreover, deterioration of a member and a device that include the optical film can be suppressed. For example, in case of a display device, display quality can be stably maintained in a favorable condition for a long period of time.

The volatile component herein is a minute amount of substance having a molecular weight of not more than 200 contained in the layer. Examples thereof may include a residual monomer and a solvent. The amount of the volatile component may be quantitatively determined, as the total of substances with a molecular weight of not more than 200 contained in the film, by analyzing the film as a measurement object using a gas chromatography.

The optical film preferably has a long-length shape. The term “long-length shape” refers to a film having a length of at least about five times or more, preferably a length of ten times or more the film width, and specifically refers to a film having a length such that it is wound to be in a form of a roll for storage or transportation.

The width of the optical film is preferably 700 mm or more, more preferably 1000 mm or more, and particularly preferably 1200 mm or more, and is preferably 2500 mm or less, more preferably 2200 mm or less, and particularly preferably 2000 mm or less.

[5. Production Method]

The optical film may be produced by molding the cyclic olefin resin as a material of the olefin resin layer, and the resin as a material of the coating layer as necessary, into a film shape. Examples of such a molding method may include a melt molding method and a solution casting method. Examples of the melt molding method may include a melt extrusion method in which molding is performed by melt extrusion, a press molding method, an inflation molding method, an injection molding method, a blow molding method, and a stretch molding method. Of these, the melt extrusion method, the inflation molding method, and the press molding method are preferable from the viewpoint of obtaining a film excellent in mechanical strength and surface precision. Of these, in particular, the melt extrusion method is particularly preferable since an amount of residual solvent can be reduced and efficient and simple production can be achieved.

The optical film having two or more layers is preferably produced by a co-extrusion method which is a type of the melt extrusion method. Examples of the co-extrusion method may include a co-extrusion T-die method, a co-extrusion inflation method, and a co-extrusion lamination method. Of these, the co-extrusion T-die method is preferable. The co-extrusion T-die method is performed in a feed block system and a multi-manifold system, and the multi-manifold system is particularly preferable since fluctuation in the thickness can be reduced.

Further, the optical film having two or more layers may also be produced in a manner such that the olefin resin layer and the coating layer are separately produced and then the olefin resin layer and the coating layer thus produced are bonded to each other to produce the optical film.

Further, when the optical film is produced, an optional step other than the steps described above may be performed. For example, a step of stretching the optical film may be performed.

[6. Method of Cutting Optical Film]

In cutting the optical film of the present invention, the optical film is irradiated in a desired region with CO₂ laser light in a state of being supported by a supporting surface of a supporting body. The region of the optical film irradiated with the laser light is heated with energy of the laser light, whereby thermal melting or ablation occurs in this region. As a result, the optical film is cut at the region irradiated with the laser light. During this process, the optical film of the present invention can efficiently absorb the CO₂ laser light with a wavelength of 9.4 μm or 10.6 Consequently, the optical film can be easily cut even with low-output CO₂ laser light. Further, since the output of the CO₂ laser light can be reduced, usually the supporting body is not cut with the CO₂ laser light.

[7. Application of Optical Film]

There is no limitation to an application of the optical film of the present invention, and the optical film may be used for any optical applications. Further, the optical film may be used alone or in combination with any other members. For example, the optical film may be incorporated and used in a display device such as a liquid crystal display device, an organic electroluminescent display device, a plasma display device, an FED (field emission display) device, and a SED (surface field emission display) device.

Further, for example, the optical film of the present invention may be used as a protective film for a polarizer.

Further, for example, the optical film of the present invention may be used as a phase difference film to be combined with a circularly polarizing film, thereby obtaining a brightness enhancing film.

### EXAMPLES

Hereinafter, the present invention will be specifically described by referring to Examples. However, the present invention is not limited to the following Examples. The present invention may be freely modified and practiced without departing from the scope of claims of the present invention and equivalents thereto.

Unless otherwise specified, “%” and “part” that represent an amount of a material in the following description are based on weight. Further, unless otherwise specified, the operations described below were performed under the conditions of normal temperature and normal pressure.

[Evaluation Methods]

(Method of Measuring Saturated Water Absorption Rate)

A saturated water absorption rate of an optical film was measured by the following procedures in accordance with JIS K7209.

The optical film was dried at 50° C. for 24 hours and allowed to cool in a desiccator. Then, the weight (M1) of the dried optical film was measured.

The dried optical film was immersed in water for 24 hours in a chamber at a temperature of 23° C. and a relative humidity of 50% for completing saturation of the optical film with the water. Then, the optical film was taken out of the water to measure the weight (M2) of the optical film that had been immersed in the water for 24 hours.

The saturated water absorption rate of the optical film was obtained from these measured values of the weight by the following formula.

Saturated water absorption rate (%)=[(M2−M)/M]×100(%)

(Method of Measuring Average Light Absorbance)

A light absorbance of an optical film was measured at wavelength intervals of 0.01 μm in a wavelength range of 9 to 11 and then an average value thereof was calculated. The above-mentioned average value was calculated as an average light absorbance of the optical film in the wavelength range of 9 μm to 11 As a measuring instrument, a Fourier transform infrared spectroscopic analyzer (“Frontier MIR/NIR” manufactured by PerkinElmer Co., Ltd.) was used. As the measuring method, a transmission method was employed.

(Evaluation of Cutting)

An optical film was placed on a glass plate (thickness of 1.5 mm). A surface of the optical film opposite to the glass plate was irradiated with CO₂ laser light having a wavelength of 9.4 μm so as to cut the optical film. The output of the laser light was adjusted to accomplish cutting of the optical film. Specifically, the output of the laser light was first set at a low level and gradually increased. Irradiation of the laser light was ceased at the time point of completing the cutting of the optical film or the time point of occurrence of glass plate breakage. During this operation, the output of the laser light was set to be 45 W=100%.

After irradiation with the laser light as described above, the optical film and the glass plate were observed and evaluated in accordance with the following criteria.

“A”: Cutting of only the optical film without damaging the glass plate was accomplished.

“B”: Cutting of only the optical film without damaging the glass plate was accomplished. However, there was a large bump of resin caused by thermal melting on the cut surface of the optical film.

“C”: Cutting of the optical film was not accomplished or glass plate breakage occurred.

### Production Example 1 (Production of Cyclic Olefin Resin A)

(Materials of Resin A)

Cyclic olefin polymer (“ARTON G” manufactured by JSR Corp.; including polar group): 92 parts

Diethylene glycol dibenzoate (molecular weight of 314, melting point of 24° C.): 8 parts

Methylene chloride: 300 parts

Ethanol: 10 parts

(Melting Step)

The materials mentioned above were placed in a melting pot, heated to 60° C., and completely melted by stirring so as to obtain a cyclic olefin resin solution. The melting step took 6 hours.

(Filtering Step)

Subsequently, the cyclic olefin resin solution was filtered through a filter (“Zeta-plus filter 30H” manufactured by CUNO, pore size of 0.5 μm to 1 μm), and further filtered through another metal fiber filter (manufactured by Nichidai Co., Ltd., pore size of 0.4 μm) to remove a minute solid content from the cyclic olefin resin solution.

(Drying Step and Molding Step)

Subsequently, the cyclic olefin resin solution was dried at a temperature of 270° C. and a pressure of not more than 0.001 MPa using a cylindrical concentration dryer (manufactured by Hitachi Ltd.). By this operation, the solvent methylene chloride and other volatile components were removed from the cyclic olefin resin solution, to thereby obtain a solid content of the resin. The solid content of the resin in a molten state was extruded in a strand shape from a die directly connected to the above-mentioned concentration dryer. The extruded solid content of the resin was cooled and cut using a pelletizer to obtain a pellet-shaped cyclic olefin resin A.

### Production Example 2 (Production of Cyclic Olefin Resin B)

(Ring Opening Polymerization Step)

A monomer mixture containing dicyclopentadiene (hereinafter referred to as “DCP”), tetracyclododecene (hereinafter referred to as “TCD”), and methanotetrahydrofluorene (hereinafter referred to as “MTF”) at a weight ratio of 60/35/5 was prepared.

In a reaction vessel that had been subjected to nitrogen purging, 7 parts of the above-mentioned monomer mixture (1% by weight with respect to the total amount of monomers used for polymerization) and 1600 parts of cyclohexane were placed. To this mixture, 0.55 parts of tri-i-butylaluminum, 0.21 parts of isobutyl alcohol, 0.84 parts of diisopropyl ether as a reaction conditioning agent, and 3.24 parts of 1-hexene as a molecular weight regulator were further added.

To this mixture, 24.1 parts of a tungsten hexachloride solution prepared by dissolving tungsten hexachloride in cyclohexane at a concentration of 0.65% was further added, and the mixture was stirred at 55° C. for 10 min.

Subsequently, 693 parts of the above-mentioned monomer mixture and 48.9 parts of the tungsten hexachloride solution prepared by dissolving tungsten hexachloride in cyclohexane at a concentration of 0.65% were continuously added dropwise to the reaction system over 150 minutes while maintaining the system at 55° C.

Then, the reaction was continued for another 30 minutes to complete the polymerization, thereby obtaining a ring opening polymerization reaction solution that contains a ring-opening polymer. After completing the polymerization, a polymerization conversion ratio of monomers was measured by a gas chromatography. The ratio was 100% at the time of completing the polymerization.

(Hydrogenation Step)

The ring opening polymerization reaction solution thus obtained was transferred to a pressure-resistant hydrogenation reaction vessel. Then, 1.4 parts of a nickel catalyst supported on diatomaceous earth (“T8400RL” manufactured by Nikki Chemical Co., Ltd., nickel carrying rate of 57%) and 167 parts of cyclohexane were added to perform a reaction at 180° C. for 6 hours under a hydrogen pressure of 4.6 MPa to obtain a reaction solution. This reaction solution was subjected to pressure filtration (product name “FUNDABAC filter” manufactured by IHI Corp.) under a pressure of 0.25 MPa using Radiolite#500 as a filtration bed to remove the hydrogenation catalyst, thereby obtaining a colorless and transparent hydrogenated product solution that contains a hydrogenated product of the ring-opening polymer.

(Ester Compound Addition Step)

Subsequently, 5 parts of pentaerythritol tetrabenzoate (molecular weight of 552, melting point of 102.0° C. to 106.0° C.) per 95 parts of the hydrogenated product contained in the hydrogenated product solution described above were added and dissolved in the hydrogenated product solution.

(Filtering Step)

Subsequently, the hydrogenated product solution was filtered through a filter (“Zeta-plus filter 30H” manufactured by CUNO, pore size of 0.5 μm to 1 μm), and further filtered through another metal fiber filter (manufactured by Nichidai Co., Ltd., pore size of 0.4 μm) to remove a minute solid content from the hydrogenated product solution.

(Drying Step and Molding Step)

Subsequently, the hydrogenated product solution was dried at a temperature of 270° C. and a pressure of not more than 1 kPa using a cylindrical concentration dryer (manufactured by Hitachi Ltd.). By this operation, the solvent cyclohexane and other volatile components were removed from the hydrogenated product solution, to thereby obtain a solid content of the resin. The solid content of the resin in a molten state was extruded in a strand shape from a die directly connected to the above-mentioned concentration dryer. The extruded solid content of the resin was cooled and cut using a pelletizer to obtain a pellet-shaped cyclic olefin resin B containing the hydrogenated product of the ring-opening polymer.

### Production Example 3 (Production of Cyclic Olefin Resin C)

A pellet-shaped cyclic olefin resin C containing a hydrogenated product of the ring-opening polymer was obtained in the same manner as in Production Example 2, except that the “ester compound addition step” of adding pentaerythritol tetrabenzoate to the hydrogenated product solution was not performed.

### Production Example 4 (Production of Cyclic Olefin Resin D)

(Materials of Resin D)

Cyclic olefin polymer (“ARTON G” manufactured by JSR Corp.): 89 parts

Triphenyl phosphate (molecular weight of 326, melting point of 50° C.): 8 parts

Ethyl phthalyl ethyl glycolate (molecular weight of 280, melting point of 22° C.): 3 parts

Methylene chloride: 300 parts

Ethanol: 10 parts

(Melting Step)

The materials mentioned above were placed in a melting pot, heated to 60° C., and completely melted by stirring to obtain a cyclic olefin resin solution. The melting step took 6 hours.

(Filtering Step)

Subsequently, the cyclic olefin resin solution was filtered through a filter (“Zeta-plus filter 30H” manufactured by CUNO, pore size of 0.5 μm to 1 μm), and further filtered through another metal fiber filter (manufactured by Nichidai Co., Ltd., pore size of 0.4 μm) to remove a minute solid content from the cyclic olefin resin solution.

(Drying Step and Molding Step)

Subsequently, the cyclic olefin resin solution was dried at a temperature of 270° C. and a pressure of 0.001 MPa or less using a cylindrical concentration dryer (manufactured by Hitachi Ltd.). By this operation, the solvent methylene chloride and other volatile components were removed from the cyclic olefin resin solution, to thereby obtain a solid content of the resin. The solid content of the resin in a molten state was extruded in a strand-like shape from a die directly connected to the above-mentioned concentration dryer. The extruded solid content of the resin was cooled and cut using a pelletizer to obtain a pellet-shaped cyclic olefin resin D.

### Production Example 5 (Production of Cyclic Olefin Resin E)

A pellet-shaped cyclic olefin resin E was obtained in the same manner as Production Example 2, except that bis(2-ethylhexyl) adipate was used in place of pentaerythritol tetrabenzoate in the “ester compound addition step”.

### Example 1

A film melt-extrusion molding machine (stationary type, manufactured by GSI Creos Corp.) of a hanger manifold T-die type equipped with a screw having a screw diameter of 20 mmϕ, a compression ratio of 3.1, and L/D=30, was prepared.

The cyclic olefin resin A produced in Production Example 1 was molded into a film shape using the above-mentioned film melt-extrusion molding machine to obtain an optical film having a thickness of 0.02 mm. The molding was performed under the following conditions: a die lip of 0.8 mm, a T-die width of 300 mm, a molten resin temperature of 260° C., and a cooling roll temperature of 110° C.

The optical film thus obtained was evaluated by the above-mentioned methods.

### Example 2

An optical film having a thickness of 0.02 mm was obtained in the same manner as in Example 1, except that the cyclic olefin resin B produced in Production Example 2 was used as the resin in place of the cyclic olefin resin A.

The optical film thus obtained was evaluated by the above-mentioned methods.

### Example 3

A film melt-extrusion molding machine (stationary type, manufactured by GSI Creos Corp.) of a hanger manifold T-die type for double layer co-extrusion equipped with two screw extruders each having a screw diameter of 20 mmϕ, a compression ratio of 3.1, and L/D=30, was prepared.

The cyclic olefin resin C produced in Production Example 3 and the cyclic olefin resin B produced in Production Example 2 were molded into a film shape using the above-mentioned film melt-extrusion molding machine to obtain an optical film having a layer structure of two layers of two types. The molding was performed under the following conditions: a die lip of 0.8 mm, a T-die width of 300 mm, a molten resin temperature of 260° C., and a cooling roll temperature of 110° C.

The optical film thus obtained had a layer of the cyclic olefin resin C and a layer of the cyclic olefin resin B, and its total thickness was 0.025 mm. The thickness ratio of the two layers was as follows. Cyclic olefin resin C layer:cyclic olefin resin B layer=0.005 mm:0.02 mm.

The optical film thus obtained was evaluated by the above-mentioned methods.

### Example 4

An optical film having a thickness of 0.02 mm was obtained in the same manner as in Example 1, except that the cyclic olefin resin E produced in Production Example 5 was used as the resin in place of the cyclic olefin resin A.

The optical film thus obtained was evaluated by the above-mentioned methods.

### Comparative Example 1

An optical film having a thickness of 0.02 mm was obtained in the same manner as in Example 1, except that the cyclic olefin resin C produced in Production Example 3 was used as the resin in place of the cyclic olefin resin A.

The optical film thus obtained was evaluated by the above-mentioned methods.

### Comparative Example 2

An optical film having a thickness of 0.02 mm was obtained in the same manner as in Example 1, except that the cyclic olefin resin D produced in Production Example 4 was used as the resin in place of the cyclic olefin resin A. The optical film thus obtained was evaluated by the above-mentioned methods.

[Results]

Results of Examples and Comparative Examples described above are shown in Table 1 below. The meanings of abbreviations used in Table 1 are as follows.

DEGDB: diethylene glycol dibenzoate

PETB: pentaerythritol tetrabenzoate

TPP: triphenyl phosphate

EPEG: ethyl phthalyl ethyl glycolate

DEHA: bis(2-ethylhexyl) adipate

TABLE 1
[Results of Examples and Comparative Examples]

| | | | | | Comparative | Comparative |
|---|---|---|---|---|---|---|
| | Example 1 | Example 2 | Example 3 | Example 4 | Example 1 | Example 2 |
| Production example | Production | Production | Production | Production | Production | Production |
| of resin | Example 1 | Example 2 | Example 3/ | Example 5 | Example 3 | Example 4 |
| | | | Production | | | |
| | | | Example 2 | | | |
| Resin | Resin A | Resin B | Resin C/ | Resin E | Resin C | Resin D |
| | | | Resin B | | | |
| Amount of cyclic | 92 | 95 | 100/95 | 95 | 100 | 89 |
| olefin polymer | | | | | | |
| (part) | | | | | | |
| Types of ester | DEGDB | PETB | —/PETB | DEHA | — | TPP and |
| compound | | | | | | EPEG |
| Amount of ester | 8 | 5 | 0/5 | 5 | 0 | 11 |
| compound (part) | | | | | | |
| Thickness | 20 μm | 20 μm | 5 μm/20 μm | 20 μm | 20 μm | 20 μm |
| Laser output (%) | 15 | 15 | 16 | 15 | 18 | 15 |
| Cut evaluation | A | A | A | A | C | B |
| Average light | 0.8% | 0.6% | 0.6% | 0.5% | 0.08% | 0.9% |
| absorbance | | | | | | |
| Saturated water | 0.05 | 0.014 | 0.02 | 0.02 | 0.026 | 0.07 |
| absorption rate (%) | | | | | | |

[Discussions]

As shown in Table 1, cutting of the optical film was not accomplished with low-output CO₂ laser light in Comparative Example 1 in which the olefin resin layer contained no ester compound. Cutting of the optical film was accomplished with low-output CO₂ laser light in each of Examples 1 to 4 in which the olefin resin layer contained the ester compound.

When the ratio of the ester compound in the olefin resin layer is excessive as in Comparative Example 2, cutting of the optical film with low-output CO₂ laser light can be performed, although a large bump of the resin is formed on a cut surface of the optical film due to thermal melting. Therefore, it is evident that the ratio of the ester compound needs to be appropriately controlled in order to avoid undesired deformation of the optical film and achieve favorable cutting.

1. A method for producing a cut optical film comprising a step of irradiating an optical film with CO₂ laser light to cut the optical film, the optical film including an olefin resin layer that contains a cyclic olefin polymer and an ester compound, the ratio of the ester compound in the olefin resin layer being 0.1% by weight to 10% by weight, wherein
an average light absorbance of the optical film in a wavelength range of 9 μm to 11 μm is 0.1% or more.

2. The method according to claim 1, wherein the cyclic olefin polymer contains no polar group in a molecule thereof.

3. The method according to claim 1, wherein the optical film has a saturated water absorption rate of 0.05% or less.

4. The method according to claim 1, wherein the ester compound includes an aromatic ring in a molecule thereof.

5. The method according to claim 1, wherein the optical film comprises a coating layer formed on one surface or both surfaces of the olefin resin layer.

6. The method according to claim 5, wherein the coating layer is formed of a thermoplastic resin containing the cyclic olefin polymer.

7. The method according to claim 5, wherein the coating layer contains no ester compound.

8. The method according to claim 5, wherein the cyclic olefin polymer in the coating layer contains no polar group in a molecule thereof.
